(19) United States
(12) Patent Application Publication
(10) Pub. No.: US 2011/0186076 A1
(43) Pub. Date: Aug. 4, 2011

(54) CLEANING METHOD

(76) Inventor: Debbie C. Appleton, Rochester, NY (US)

(21) Appl. No.: 12/696,720

(22) Filed: Jan. 29, 2010

(51) Int. Cl. B08B 7/00

(52) U.S. Cl. 134/6

(57) ABSTRACT

A method of cleaning a skin-contacting surface associated with a hand-held device includes providing a substantially dry, porous, thermoplastic wipe, contacting the skin-contacting surface with the wipe, and moving the wipe relative to the surface while the wipe is in contact with the surface.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

1. Field of the Invention

The present disclosure relates to a method and apparatus for cleaning a hand-held device, and in particular, a method and apparatus for cleaning a skin-contacting surface associated with a hand-held device.

2. Description of Related Art

Human skin, such as facial skin, continuously produces sebum and other like oils. Even with normal washing, these facial oils may remain on the skin and may continue to accumulate over the course of time. As a result, when items such as conventional telephone receivers, cellular phones, personal digital assistance (“PDAs”), and other hand-held devices are placed into contact with the face during use, such oils may rub off onto and/or may be otherwise transposed onto a skin-contacting surface associated with the hand-held device. Oils on the user's hands may also be transposed onto such surfaces during use, resulting in the appearance of fingerprints or other marks on these surfaces.

Moreover, it is common to apply make-up to certain portions of the face such as, for example, the nose, cheeks, lips, and forehead. Such make-up and other cosmetics may also rub off onto hand-held devices coming into contact with the face. It is understood that the facial oils and cosmetics discussed above may form an unsightly and generally undesirable film on the face contacting surfaces associated with such hand-held devices. Such a film may dramatically reduce the aesthetics of the hand-held device, and may also reduce the effectiveness of the device by, for example, reducing the sensitivity of a touch-screen of the device or by generally reducing the viewability of a screen or other operator interface of the device.

Wipes for removing oils and cosmetics from human skin are well known in the art. Such exemplary wipes are disclosed in, for example, U.S. Pat. Nos. 6,638,611 (“Seth”) and 6,533,119 (“Hansen et al”). Such wipes are also marketed by, for example, Johnson & Johnson Consumer Companies, Inc. as Clean & Clear® makeup dissolving facial cleansing wipes and Clean & Clear® oil absorbing sheets. Although such known products may be configured for use in removing oils and make-up, the user instructions associated with these products typically only suggest using the products to remove such contaminants from facial skin. The instructions make no indication that such products may also be used to remove these contaminants from, for example, a skin-contacting surface associated with a hand-held device or other like electrical equipment. In fact, products such as the Clean & Clear® oil absorbing sheets actually include mineral oils as an ingredient.

Most known facial wipes also contain ingredients such as water, acids, alcohols, and/or other like cleaning agents that may damage conventional hand-held devices. For example, the Clean & Clear® makeup dissolving facial cleansing wipe ingredient listing includes, among other things, water, benzoic acid, and dehydroacetic acid. Such agents are known to be harmful to electrical equipment and many, if not most, hand-held device operator manuals or cleaning instructions specifically warn against subjecting the devices to water, alcohol, solvents, cleaners, or other such chemicals. For example, the BlackBerry® Safety and Product Information explicitly instructs users not to use liquid, aerosol cleaners, or solvents on or near the BlackBerry® device or device accessories. Instead, the associated literature indicates that the BlackBerry® device should be cleaned only with a soft dry cloth. Similarly, the iPhone® cleaning instructions warn users not to use window cleaners, household cleaners, aerosol sprays, solvents, alcohol, ammonia, or abrasives to clean the iPhone®. Instead, these instructions teach that a soft, slightly damp, lint-free cloth should be used to remove oil left by the user's hands and face. Based on the warnings included in such operator manuals or instructions, and the ingredient listings included with most known facial wipes, hand-held device users would not be motivated to use such wipes to remove contaminants from and/or otherwise clean skin-contacting surfaces associated with their hand-held devices for fear of damaging these devices.

Moreover, similar to the BlackBerry® and iPhone® cleaning instructions discussed above, most hand-held device operator manuals or cleaning instructions typically advise using only a soft cloth for cleaning. However, because many known facial wipes are made from, for example, thermoplastics and/or other non-cloth materials, hand-held users would not be motivated to use such wipes to clean these devices for at least this additional reason.

Wipes for glass or plastic eye lenses are also well known, and such wipes are marketed by, for example, CVS Pharmacy, Inc.® as pre-moistened lens wipes for glass or plastic lenses. But, these wipes suffer from the same deficiencies associated with the facial wipes discussed above. While the instructions associated with such wipes suggest using these wipes to clean, for example, tv/computer screens and mobile phone displays, the ingredient listing for these wipes typically includes both isopropyl alcohol and water. Because such wipes are pre-moistened and include both alcohol and water as ingredients, using these wipes to clean the above electrical equipment would be contradictory to accepted practice. As noted above, because the user manuals included with most tvs, computers, hand-held devices, and other like electrical equipment specifically warns against contacting such devices with, for example, water and cleaning agents, a user of such devices is not likely to use known pre-moistened wipes for cleaning these devices for fear of damaging such devices.

The exemplary embodiments disclosed herein are aimed at overcoming one or more of the deficiencies associated with the prior art.

### BRIEF SUMMARY OF THE INVENTION

In an exemplary embodiment of the present disclosure, a method of cleaning a skin-contacting surface associated with a hand-held device includes providing a substantially dry, porous, thermoplastic wipe, contacting the skin-contacting surface with the wipe, and moving the wipe relative to the surface while the wipe is in contact with the surface.

According to another exemplary embodiment of the present disclosure, a method of cleaning a skin-contacting surface associated with a hand-held device includes removing facial oil from the surface with a substantially dry, porous, thermoplastic wipe including a nonparticulate. In such an exemplary embodiment, the wipe is configured to remove the facial oil from human skin.

In still another exemplary embodiment of the present disclosure, a method of cleaning a skin-contacting surface associated with a hand-held device includes increasing transparency of a porous thermoplastic wipe by removing contaminants from the surface with the wipe.

In still another exemplary embodiment of the present disclosure, a method of cleaning a touch-screen includes providing a substantially dry, porous, thermoplastic wipe, contacting the touch-screen with the wipe, and moving the wipe relative to the touch-screen while the wipe is in contact with the touch-screen.

### BRIEF DESCRIPTION OF THE SEVERAL VIEWS OF THE DRAWING(S)

FIG. 1 illustrates a wipe according to an exemplary embodiment of the present disclosure.

FIG. 2 illustrates the wipe of FIG. 1 and an exemplary hand-held device.

FIG. 3 is an isometric view of a wipe and a hand-held device disposed within an exemplary device case.

FIG. 4 illustrates a hand-held device disposed within a hand-held device case according to another exemplary embodiment of the present disclosure.

FIG. 5 illustrates the wipe of FIG. 1 and an exemplary touch-screen.

### DETAILED DESCRIPTION OF THE INVENTION

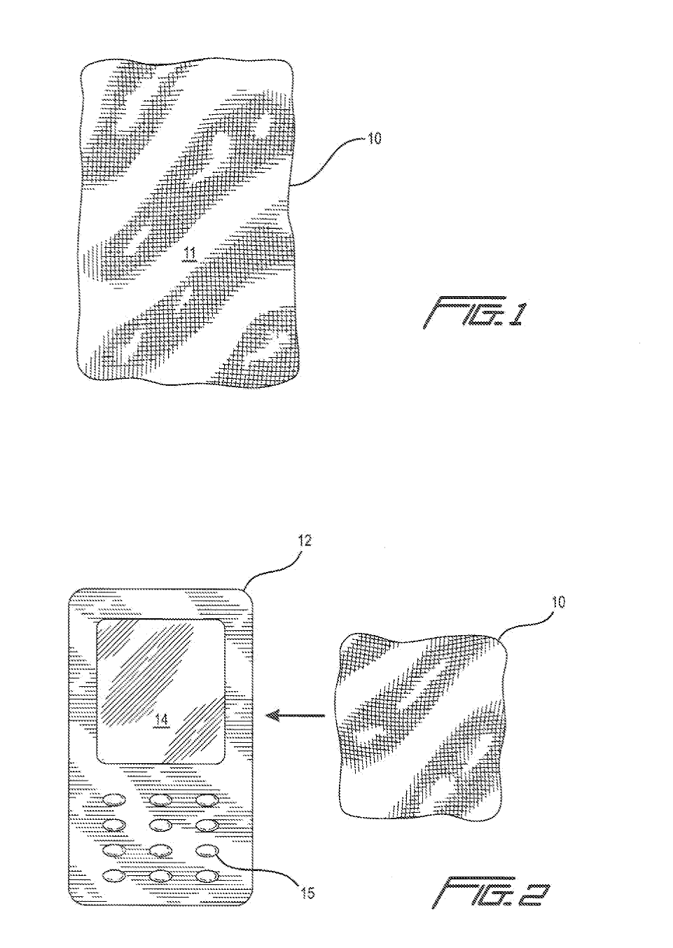

FIG. 1 illustrates a wipe 10 according to an exemplary embodiment of the present disclosure. The wipe 10 may have any shape, size, dimension, and/or other configuration known in the art. For example, the wipe 10 may be shaped, sized, dimensioned, and/or otherwise configured to be stored within a package in a substantially stacked, overlapping, folded, and/or other configuration. For example, one or more wipes 10 may be stored within a packaging useful for commercial sale. In such an exemplary embodiment, a single wipe 10 may be disposed within such a package or a plurality of wipes may be, for example, stacked such that a surface 11 of one wipe 10 may substantially overlap a portion or like surface 11 of an adjacent wipe 10. Generally, such packages may contain at least two wipes 10 and may contain 10, 20, 30, or more wipes 10.

The wipes 10 described in the present disclosure may be substantially similar to, for example, the Clean & Clear® oil absorbing sheets marketed by Johnson & Johnson Consumer Companies, Inc.® and/or other like facial wipes known in the art. In an exemplary embodiment, the wipe 10 may be substantially dry. As used herein, the term “substantially dry” is understood to mean having only traces or substantially no water or other liquids disposed on the surface 11 of the wipe 10. Thus, although water and/or other liquids may be used in the manufacture, packaging, and/or storage of a substantially dry wipe 10, surface 11 of a substantially dry wipe 10 may be substantially void of such water or other liquids once the wipe 10 is removed from its associated packaging and/or otherwise prior to use of the wipe 10.

The wipe 10 may be approximately 2-in wide by approximately 3-in long, however, wipes 10 having larger or smaller length and width dimensions have also been found to be acceptable. The wipe 10 may also have a minimal thickness so as to minimize, for example, the corresponding thickness of the wipe packaging. In an exemplary embodiment, the wipe 10 may have a thickness of approximately 0.05-in, however, wipes 10 having a thickness of greater than or less than 0.05-in have also been found to be acceptable.

The wipe 10 may have one or more patterns, designs, and/or other configurations on the surface 11 thereof. Such patterns may assist in, for example, capturing, collecting, and/or removing contaminants with which the wipe 10 is placed into contact. As used herein, the term “contaminants” is understood to include, for example, dirt, sebum, human skin oils such as facial oils, fingerprints, make-up or cosmetics, dead skin or epidermal cells, and/or other like substances. In an exemplary embodiment, such patterns may reduce the wipe's rigidity, improve the texture and/or feel of the wipe 10, and may increase the transparency of a patterned portion of the wipe 10 relative to a non-patterned portion of the wipe 10. Such patterns may comprise, for example, continuous and/or connected elements such as grids, connected lines, dots, and/or other patterns. It is understood that such patterns may be formed across the entire surface 11 of the wipe 10 or, alternatively, such patterns may be formed on only a portion of the surface 11.

The wipe 10 may be formed from any material known in the art to assist in capturing, collecting, and/or removing contaminants. For example, the wipe 10 may be made from a porous thermoplastic film, and in an exemplary embodiment, the wipe 10 may comprise a porous, stretched or oriented film made from a thermoplastic material. In the exemplary embodiments discussed herein, the material from which the wipe 10 is formed may be coated on at least a portion of the surface 11 with one or more cleaning agents, materials, and/or oil-absorbing layers as is commonly done in the art.

The porous thermoplastic film and/or other material used to form the wipe 10 may be produced by various known methods, and such methods may utilize a thermoplastic material as a starting substance in such formation. In an exemplary method, a translucent crystal in thermoplastic resin may be used as a starting substance. Such a material may be formed into a relatively thin film using conventional casting, blown extrusion, and/or other film forming methods. The formed film may then be stretched and/or otherwise expanded to create a desired level of porosity and/or to otherwise create relatively small voids in the material. Alternatively, materials such as polytetrafluoroethylene may be used as the starting substance, and rapidly stretching such a material may create a porous network therein.

Because a thermoplastic film used to form the wipe 10 may have a relatively uniform distribution of small voids therein, the material may appear to be opaque and/or otherwise substantially nontransparent due to light dispersion caused by the pore structure. However, after the wipe 10 is used to capture, collect, and/or remove contaminants, the contaminants may substantially fill these voids or pores. Filling the pores in this way may reduce and/or substantially prevent the dispersion of light, thus increasing the transparency of the wipe 10. This change in transparency of the wipe 10 may allow the oil-absorbing effect and, in particular, the amount of oil removed by the wipe 10, to be clearly assessed by the user.

As discussed above, a variety of different materials may be used as a starting substance in forming the wipe 10. Such materials may also include, but are not limited to, for example, polyethylene, polypropylene, polybutene, and other like polymers. Such materials may further include, for example, cloth, paper, tissue, hemp, and/or other like organic or inorganic materials. Some such materials may be, for example, woven and/or otherwise formed for use as a substance for the wipe 10. As is also discussed above, one or more fillers may be added to the above materials during manufacture, and the resulting film may then be stretched to create fine voids therein. Exemplary nonparticulate fillers that have been found to be acceptable for this purpose include, but are not limited to, mineral oils, petroleum jelly, low molecular weight polyethylene, waxes and/or mixtures thereof. Such nonparticulate fillers may assist in, for example, increasing the transparency of the wipe 10 upon absorption of one or more of the contaminants discussed above.

In general, the wipes 10 described herein are characterized by their ability to change from relatively opaque structures to a substantially translucent structure upon absorbing a moderate amount of contaminants such as, for example, oil or sebum. Such moderate amounts may be substantially equal to the amount of contaminants present on a user's hands, fingers, face, skin, or on a skin-contacting surface associated with a hand-held device. Such amounts may be, for example, from approximately 0 mg/cm² square to approximately 8 mg/cm². Upon capturing, collecting, and/or removing such contaminants, the wipes 10 disclosed herein may experience an increase in transparency and may become, for example, substantially translucent. As discussed above, such a change in transparency of the wipe 10 may serve as an indication that the contaminants have been removed from the surface and/or structure on which the contaminants were disposed.

In an exemplary embodiment, an initial transparency of the wipe 10 may be, approximately, 65 percent or less, and the wipe 10 may have the ability to change transparency by about approximately 20 percentage points or more with a relatively low level of contaminant loading such as, for example, between approximately 6 mg/cm² and approximately 8 mg/cm². The transparency of the wipe 10 may be reported as a percentage in accordance with and/or as measured by a Gardiner Haze Guard Plus Haze Meter following the procedure in ASTM D1003. For example, upon absorption of an appropriate amount of contaminants, the transparency value of the wipe 10 may increase to provide an indication to the user that the wipe 10 has, for example, absorbed the contaminant. It is understood that the transparency value of approximately 0 percent indicates substantially no light transmittance, where a transparency value of close to 100 percent indicates a substantially completely transparent structure.

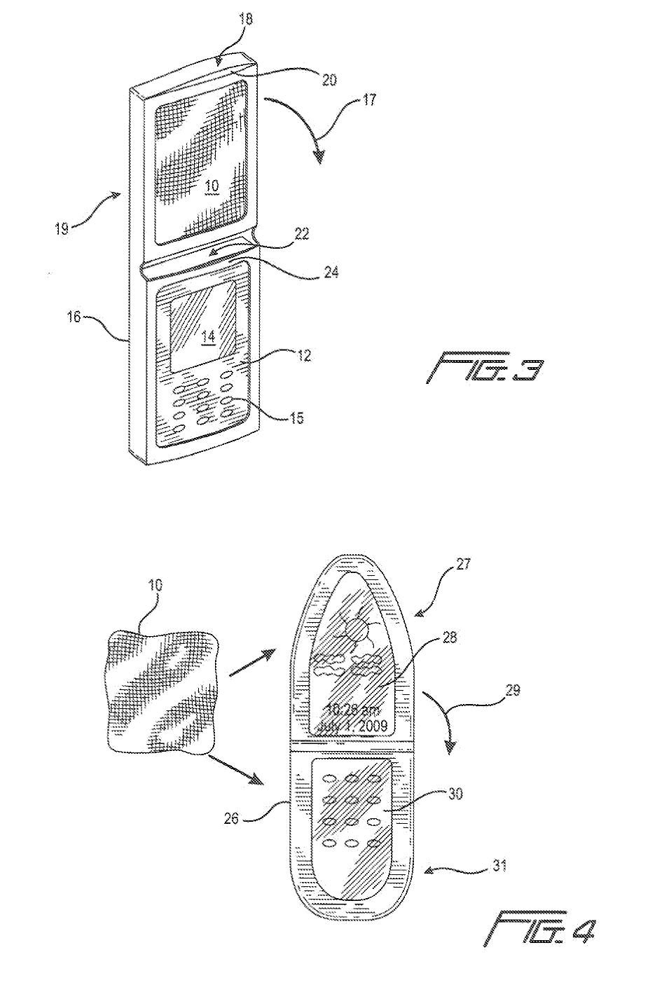

FIG. 2 illustrates an exemplary hand-held device 12 of the present disclosure. The hand-held device 12 may be, for example, a cellular phone, PDA, BlackBerry®, iPhone®, pocket pc, dictaphone, conventional telephone receiver, wireless telephone receiver, MP3 player, IPOD®, and/or any other like electrical device configured for hand-held and/or otherwise portable use. Such hand-held devices may include, for example, a screen 14. The screen 14 may be, for example, a touch-screen and/or any other like screen commonly used with such contemporary hand-held devices 12. The hand-held device 12 may also include any number of conventional buttons 15 convenient for inputting data, information, commands, or the like into the hand-held device 12. Together, the screen 14 and buttons 15 may be regarded as “operator interfaces,” and these operator interfaces may facilitate use of the hand-held device 12 by a user.

It is understood that, in an exemplary embodiment, the hand-held device 12 may comprise a cellular telephone, and during use, at least a portion of the hand-held device 12 may be placed in contact with, for example, the face of the user. For example, during use, the hand-held device 12 may be placed proximate an ear of the user and the screen 14 of the hand-held device may, thus, contact the cheek, nose, lips, hands, fingers, and/or other portions of the user's face or skin. It is also possible that the buttons 15 and/or other portions of the hand-held device 12 may come in contact with, for example, the user's face, hands, fingers, or skin during use of the hand-held device 12. As a result of such contact, any of the contaminants discussed above may rub off onto and/or otherwise be transposed onto the screen 14, buttons 15, and/or other contacted portions of the hand-held device 12. Thus, the screen 14, buttons 15, and/or other portions coming into contact with, for example, the user's hands, fingers, skin, or face may be collectively referred to as “skin-contacting surfaces” associated with the hand-held device 12.

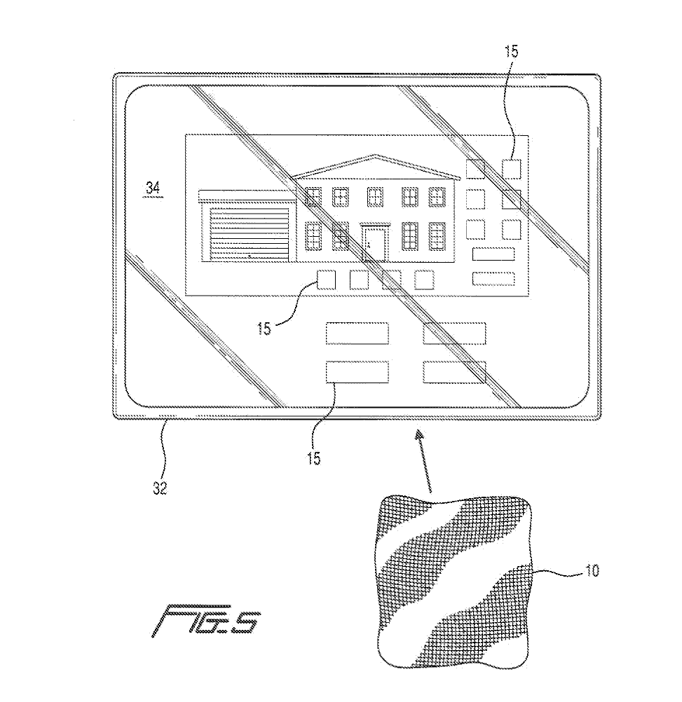

As shown in FIGS. 3 and 4, the hand-held device 12 may be disposed within a hand-held device case for protection during use. It is understood that the case may be shaped, sized, dimensioned, and/or otherwise configured based on the specific hand-held device 12 to be disposed therein. As shown in FIG. 3, an exemplary case 16 may define a hand-held device compartment 22 shaped, sized, and/or otherwise configured to receive and securably house the hand-held device 12 for use, storage, and/or transport. The case 16 may include one or more retention straps 24 configured to retain the hand-held device 12 while the device 12 is disposed within the compartment 22. In an exemplary embodiment, the retention straps 24 may be disposed about the hand-held device compartment 22 such that the screen 14, buttons 15, and/or other portions of the hand-held device 12 requiring accessibility may be substantially exposed directly to the user upon opening of the case 16. In such an exemplary embodiment, the case 16 may not include any protective covering or other layer between, for example, operator interfaces and user while the case 16 is in the open position shown in FIG. 3. It is also understood that the case 16 may be transitioned to a closed position by movement of an upper portion 19 of the case 16 in the direction of arrow 17 shown in FIG. 3. Transitioning the case 16 to the closed position may dispose the upper portion 19 substantially over the hand-held device 12 so as to protect the hand-held device 12 while not in use.

The case 16 may also define one or more pockets 18 in the upper portion 19. The pocket 18 may define an opening 20 whereby one or more items such as one or more wipes 10 may be inserted and stored within the pocket 18. In an exemplary embodiment, a wipe 10 may be disposed within the pocket 18 such that when the case 16 is in the closed position, the wipe 10 may be in direct contact with, for example, the screen 14, the buttons 15, and/or other skin-contacting surfaces associated with the hand-held device 12. Such contact between the wipe 10 disposed within the pocket 18 and the skin-contacting surfaces associated with the hand-held device 12 may assist in cleaning these surfaces by, for example, capturing, collecting, and/or removing contaminants disposed thereon. It is understood that merely contacting such surfaces with the wipe 10 may facilitate the cleaning of these surfaces. In addition, relative movement between, for example, these skin-contacting surfaces and the wipe 10 may further assist in the cleaning of these surfaces.

As shown in FIG. 4, in alternative exemplary embodiments, a case 26 may be utilized to house, for example, flip-type cellular phones and/or other like hand-held devices. Although FIG. 4 illustrates an open position of the case 26, the case 26 may be transitioned from the open position to a closed position by moving an upper portion 27 of the case 26 in the direction of arrow 29. The case 26 may include a transparent cover 28 disposed in the upper portion 27 and a transparent cover 30 disposed in the lower portion 31 of the case 26. The transparent covers 28, 30 may be made from any plastic, polymer, and/or other like material. The covers 28, 30 may be sized, located, and/or otherwise configured for use with hand-held devices disposed within the case 26. In particular, the transparent cover 28 may be shaped, sized, and located to substantially cover a screen 14 of a hand-held device 12 disposed within the case 26.

In addition, the transparent cover 30 may be shaped, sized, and located to substantially cover, for example, one or more buttons 15 of the hand-held device 12. In this way, when the hand-held device 12 is placed proximate the face of a user during use, the transparent covers 28, 30 may shield the corresponding covered portions of the hand-held device 12 from, for example, the face or skin of the user. Accordingly, the transparent covers 28, may protect the hand-held device 12 from contaminants disposed on the face or skin of the user. Instead, during use, such contaminants may rub off onto and/or be transposed onto the covers 28, 30. Through repeated use, the contaminants may, in fact, begin to build up on one or more of the covers 28, over time. Thus, it is understood, that in such an exemplary embodiment the transparent covers 28, 30 may be skin-contacting surfaces associated with the hand-held device 12.

As described above, a method of cleaning, for example, a hand-held device 12, or a skin-contacting surface associated with a hand-held device 12, may include, among other things, capturing, absorbing, collecting, trapping, and/or removing contaminants from such surfaces. Any of the wipes 10 described herein may be utilized for such purposes. Such wipes 10 may advantageously be substantially dry, substantially porous, and free from alcohol or other like cleaning agents. To clean, for example, the screen 14, buttons 15 and/or skin-contacting surfaces associated with the hand-held device 12, a wipe 10 may be placed into contact with the contaminated surface. The wipe 10 may then be moved relative to the surface while the wipe 10 remains in contact with the surface. It is understood that moving the wipe 10 may include, for example, rotating, swiping, rubbing, wiping, agitating, and/or any other like motion. Such an exemplary motion is illustrated by the arrow shown in FIG. 2. Such movement of the wipe 10 may remove one or more of the contaminants discussed above from the skin-contacting surface by capturing, absorbing, and/or collecting the contaminant onto and/or within a portion of the wipe 10.

In addition, each of the cleaning methods and cleaning structures such as, for example, the wipes 10, discussed herein may be utilized to capture, collect, and/or remove contaminants from skin-contacting surfaces other than those associated with hand-held devices. For example, as discussed above, the wipe 10 may be utilized to clean, for example, a touch-screen and/or any other like screen, and such touch-screens may be associated with a wide variety of known and commonly used devices. For example, as shown in FIG. 5, a wipe 10 may be utilized to clean a touch-screen 34 and/or other skin-contacting surface associated with a control device 32.

The control device 32 may be, for example, an electronic control panel commonly associated with known electronic devices. Such known devices may include, but are not limited to, for example, thermostats, security systems, computers, credit card processing stations, automated teller machines, point of sale terminals and/or other known devices utilizing touch-screen displays or other like displays. The touch-screen 34 of the control device 32 may be any type of touch-screen known in the art, and the touch-screen 34 may include one or more buttons 15. Together, the touch-screen 34 and the buttons 15 or other means of data entry defined by the touch-screen 34 may be regarded as “operator interfaces.” It is understood that these operator interfaces may facilitate use of the control device 32 by a user. Thus, during use, the user may contact the touch-screen 34 with the user's fingers, hands, and/or other portions of the user's skin. As discussed above, as a result of such contact, contaminants may rub off onto and/or otherwise be transposed onto the touch-screen 34, buttons 15, and/or other portions of the control device 32. Thus, it is understood that these contacted surfaces may be collectively referred to as “skin-contacting surfaces” associated with the control device 32.

As illustrated by the arrow shown in FIG. 5, a method of cleaning the touch-screen 34 and/or other skin-contacting surfaces associated with the control device 32 may include contacting such surfaces with the wipe 10 and moving the wipe 10 relative to these surfaces while the wipe 10 is in contact with the surfaces. Such contact between the wipe 10 and the skin-contacting surfaces of the control device 32 may, for example, capture, collect, and/or otherwise remove contaminants from these skin-contacting surfaces.

As illustrated in FIG. 3, cleaning a skin-contacting surface associated with hand-held device 12 may also be accomplished by storing one or more wipes 10 within a pocket 18 of an exemplary case 16. In such an exemplary embodiment, removal of the contaminant may include contacting the screen 14, buttons 15, and/or other skin-contacting surfaces associated with the hand-held device 12 with the wipe 10 while the wipe 10 is disposed within the pocket 18 of the case 16. It is also understood that in the exemplary embodiment of the case 16 shown in FIG. 3, the case 16 may further include a transparent cover disposed over substantially the entire hand-held device compartment 22 so as to substantially cover the hand-held device 12 when disposed within the compartment 22. In such an exemplary embodiment, a method of cleaning a skin-contacting surface associated with the hand-held device 12 may include contacting the transparent cover of the case 16 with the wipe 10 while the wipe 10 is disposed within the pocket 18. Regardless of whether or not the case 16 includes a transparent cover, it is understood that such contact between the wipe 10 and the skin-contacting surface associated with the hand-held device 12 may occur when, for example, the case 16 is transitioned into the closed position.

Moreover, a method of cleaning, for example, the transparent covers 28, 30 and/or other skin-contacting surfaces associated with the hand-held device 12 illustrated in FIG. 4, may include moving a wipe 10 across one or more of the surfaces while the wipe 10 is in contact with the surface. Such contact between the wipe 10 and the skin-contacting surfaces of the embodiment illustrated in FIG. 4 may occur when the case 26 is in, for example, the open position.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. A method of cleaning a skin-contacting surface associated with a hand-held device, comprising:
(a) providing a substantially dry, porous, thermoplastic wipe;
(b) contacting the surface with the wipe; and
(c) moving the wipe relative to the surface while the wipe is in contact with the surface.

2. The method of claim 1, wherein the wipe is alcohol-free.

3. The method of claim 1, wherein the wipe comprises a nonparticulate filler.

4. The method of claim 3, further including removing facial oil from the surface with the wipe.

5. The method of claim 1, wherein the wipe comprises polypropylene.

6. The method of claim 1, wherein the surface is a screen of the hand-held device.

7. The method of claim 1, wherein the surface is a transparent cover of a hand-held device case.

8. The method of claim 1, wherein moving the wipe removes a contaminant from the surface.

9. The method of claim 8, wherein the contaminant comprises facial oil.

10. The method of claim 1, wherein moving the wipe captures a contaminant from the surface on the wipe.

11. A method of cleaning a skin-contacting surface associated with a hand-held device, comprising:
removing facial oil from the surface with a substantially dry, porous, thermoplastic wipe comprising a nonparticulate filler, the wipe configured to remove the facial oil from human skin.

12. The method of claim 11, wherein removing facial oil comprises contacting the surface with the wipe, and moving the wipe across the surface while the wipe is in contact with the surface.

13. The method of claim 11, wherein the wipe is alcohol-free.

14. The method of claim 11, further including assessing the amount of facial oil removed from the surface based on a change in transparency of the wipe.

15. A method of cleaning a skin-contacting surface associated with a hand-held device, comprising:
increasing transparency of a porous thermoplastic wipe by removing contaminants from the surface with the wipe.

16. The method of claim 15, further including storing the wipe in a pocket of a hand-held device case.

17. The method of claim 16, wherein removing the contaminants comprises contacting a skin-contacting surface associated with the hand-held device with the wipe while the wipe is disposed within the pocket.

18. The method of claim 17, wherein the skin-contacting surface comprises one of a screen of the hand-held device and a transparent cover of the hand-held device case.

19. A method of cleaning a touch-screen, comprising:
(a) providing a substantially dry, porous, thermoplastic wipe;
(b) contacting the touch-screen with the wipe; and
(c) moving the wipe relative to the touch-screen while the wipe is in contact with the touch-screen.
